(19) United States
(12) Patent Application Publication
(10) Pub. No.: US 2026/0341565 A1
(43) Pub. Date: Oct. 29, 2026

(54) FIELD CHARGING SYSTEM FOR A SUPERCONDUCTING MAGNET

(71) Applicant: General Electric Renovables España, S.L., Barcelona (ES)

(72) Inventors: Anbo Wu, Clifton Park, NY (US); James William Bray, Niskayuna, NY (US); Ernst Wolfgang Stautner, Niskayuna, NY (US); Minfeng Xu, Ballston Lake, NY (US); David Allan Torrey, Galway, NY (US)

(21) Appl. No.: 19/115,923

(22) PCT Filed: Sep. 28, 2022
(86) PCT No.: PCT/US2022/044980

§ 371 Date: Mar. 27, 2025

(51) Int. Cl. H01F 6/06; H01F 6/00; H01F 6/04

(52) U.S. Cl. CPC H01F 6/06; H01F 6/006; H01F 6/04

(57) ABSTRACT

A superconducting circuit for a superconducting magnet includes a first temperature region, a second temperature region, at least one first component, at least one second component, and a field charging system. The first temperature region defines a first temperature. The second temperature region defines a second temperature, the second temperature being higher than the first temperature. The at least one first component is positioned within the first temperature region. The at least one second component is positioned within the second temperature region. The field charging system includes at least one flexible connection electrically coupling the first component and the second component. The at least one flexible connection allows for displacement and motion between the first and second components due to thermal expansion and contraction caused by the different first and second temperatures.

### STATEMENT REGARDING FEDERALLY SPONSORED RESEARCH OR DEVELOPMENT

This invention was made with Government support under Contract No. DE-EE0008787 awarded by the Department of Energy (DOE). The Government has certain rights in the invention.

### FIELD

The present disclosure relates to superconducting magnets, and more particularly, to a field charging system for a superconducting magnet, such as used within a superconducting generator.

### BACKGROUND

A superconducting machine generally includes a superconducting magnet constructed from coils of a superconducting circuit. In its superconducting state, the superconducting circuit has no electrical resistance and therefore can conduct much larger electric currents than ordinary wire, creating intense magnetic fields. Thus, superconducting magnets can produce greater magnetic fields than non-superconducting electromagnets and can be cheaper to operate because no energy is dissipated as heat in the windings. Accordingly, superconducting magnets are commonly used in magnetic resonance imaging (MRI) machines and in scientific equipment such as nuclear magnetic resonance (NMR) spectrometers, generators, mass spectrometers, fusion reactors, and particle accelerators.

During operation, the superconducting magnet windings must be cooled below their critical temperature (i.e., the temperature at which the winding material changes from the normal resistive state and becomes a superconductor). Typically, the windings are cooled to temperatures significantly below their critical temperature because a lower temperature enables the superconductive windings to withstand higher currents and magnetic fields without returning to their non-superconductive state. Thus, liquid cooling or mechanical cooling are commonly used to maintain the windings at temperatures sufficient to maintain superconductivity. In liquid cooling, a liquid cryogen (e.g., helium, hydrogen, argon or others depending on operating temperature) is used as a coolant, which has a boiling point that is far below the critical temperature of most winding materials. For example, helium boils at 4.2 Kelvin, well below the 9 Kelvin critical temperature of niobium titanium (NbTi) superconducting wire. Thus, the superconducting magnet and the liquid cryogen are contained in a thermally insulated container called a cryostat. Alternatively, mechanical cooling includes cooling of the superconducting magnet using two-stage mechanical refrigeration.

Furthermore, during operation of the superconducting magnet, the windings can be short-circuited with a piece of superconducting material once the magnet has been energized. The short circuit is made by a switch, sometimes referred to as a persistent switch, which generally refers to the piece of superconducting material inside the magnet connected across the winding ends and attached to a small heater. Thus, the windings become a closed superconducting loop, the power source can be turned off, and persistent currents can flow for extended periods of time, preserving the magnetic field. The advantage of this persistent mode is that stability of the magnetic field is better than is achievable with the best power supplies, and no energy is needed to power the windings. For example, a superconducting switch is normally wound in a bifilar fashion to minimize its electrical inductance, so it shows zero resistance and negligible inductance in a superconducting state.

Accordingly, when the superconducting magnet is first turned on, the switch is heated above its transition temperature, such that the switch is resistive. To operate in the persistent mode, the supply current is adjusted until the desired magnetic field is obtained, then the heater is turned off. The persistent switch cools to its superconducting temperature, thereby short-circuiting the windings. Then, the power source can be turned off.

To further aid this system, various components of the superconducting magnet and switch may be arranged in separate regions within the superconducting machine so as to reduce undesired thermal transfer between the components which are designed to be maintained at either cold or hot temperatures. However, displacement and motion between the various components of the superconducting magnet due to thermal expansion and contraction must be accounted for, as well as dynamic load changes that result from transitioning the magnetic field into a persistent mode.

Thus, the present disclosure is directed to an improved field charging system for a superconductive circuit that addresses the aforementioned issues.

### BRIEF DESCRIPTION

Aspects and advantages of the present disclosure will be set forth in part in the following description, or may be obvious from the description, or may be learned through practice of the present disclosure.

In one aspect, the present disclosure is directed to a superconducting circuit for a superconducting magnet. The superconducting circuit includes a first temperature region, a second temperature region, at least one first component, at least one second component, and a field charging system. The first temperature region defines a first temperature. The second temperature region defines a second temperature, the second temperature being higher than the first temperature. The at least one first component is positioned within the first temperature region. The at least one second component is positioned within the second temperature region. The field charging system includes at least one flexible connection electrically coupling the first component and the second component. The at least one flexible connection allows for displacement and motion between the first and second components due to thermal expansion and contraction caused by the different first and second temperatures.

In an embodiment, the first component includes a plurality of superconducting coils and the second component includes at least one of a thermal shield surrounding the plurality of superconducting field coils. Further, the field charging system is configured to energize the plurality of superconducting coils.

In further embodiments, the field charging system further includes a plurality of high current leads and a superconducting switch.

In additional embodiments, the plurality of high current leads further includes a pair of high-temperature superconductor (HTS) leads and a pair of resistive leads, the pair of resistive leads being one or more power feedthrough lines extending through a vacuum vessel and coupled to the pair of HTS leads via the at least one flexible connection, the pair of HTS leads coupled to the plurality of superconducting field coils and the superconducting switch.

In other embodiments, the superconducting switch is installed on a cold plate mechanically and thermally coupled with a support structure of the plurality of superconducting field coils. Further, the pair of HTS leads are secured onto the cold plate.

In still further embodiments, the connection between the pair of HTS leads and the pair of resistive leads includes the at least one flexible connection and a thermal plate.

In other additional embodiments, the pair of resistive leads include a copper, brass, phosphor bronze, or a combination thereof.

In further additional embodiments, the first temperature is less than about 10 Kelvin (K) and the second temperature is between about 35 K to about 55 K.

In still other embodiments, the superconducting circuit further includes a third temperature region defining a third temperature higher than the first and second temperature. Further, a third component is placed within the third temperature region and connected to the second component via a second flexible connection of the at least one flexible connection.

In yet another embodiment, the second component includes a thermal shield with at least one electrical component placed therein and the third component includes a vacuum vessel including at least one electrical component placed therein.

In further embodiments, the at least one flexible connection includes a braided wire.

In another aspect, the present disclosure is directed to a field charging system for energizing a plurality of superconducting coils of a superconducting magnet. The field charging system includes at least one high-temperature superconductor (HTS) lead, a power source, and at least one flexible connection. The HTS lead connects a first and second temperature, the second temperature being different from the first. The power source is at a different, third temperature for providing power to the field charging system to energize the plurality of superconducting coils. The at least one flexible connection electrically is coupled between the at least one HTS lead at the first temperature and the power source at the second temperature. Further, the at least one flexible connection allows for displacement and motion of components of the field charging system due to thermal expansion and contraction caused by the different first and second temperatures.

In an embodiment, the power source includes one or more power feedthrough lines extending through a vacuum vessel and a thermal shield of the superconducting magnet.

In another embodiment, one or more rod members are coupled to the one or more power feedthrough lines at least partially within the thermal shield.

In a further embodiment, the at least one flexible connection includes at least one first flexible connection and at least one second flexible connection, the at least one first flexible connection coupled to the one or more rod members and a first location on at least one thermal plate, the at least one second flexible connection coupled to a second location on the at least one thermal plate and the least one HTS lead.

In yet another embodiment, the field charging system further includes a superconducting switch, the at least one HTS lead and the superconducting switch coupled to the plurality of superconducting coils.

In yet another aspect, the present disclosure is directed to a method for energizing a plurality of superconducting coils of a superconducting magnet. The method includes coupling a field charging system to the plurality of superconducting coils and to at least one additional component of the superconducting magnet, the plurality of superconducting coils and the at least one additional component being maintained at different temperatures, the field charging system having a power source, at least one high-temperature superconductor (HTS) lead, and at least one flexible connection electrically coupled between the power source and the at least one HTS lead. The method further includes providing power to the field charging system via the power source to energize the plurality of superconducting coils. The at least one flexible connection allows for displacement and motion of components of the field charging system due to thermal expansion and contraction caused by the different temperatures.

In another embodiment, the method further includes coupling one or more rod members to the one or more power feedthrough lines.

In yet another embodiment, the at least one flexible connection includes at least one first flexible connection and at least one second flexible connection.

Moreover, the method further includes coupling the at least one first flexible connection to the one or more rod members at a first location on at least one thermal plate and coupling the at least one second flexible connection to a second location on the at least one thermal plate and the at least one HTS lead.

These and other features, aspects and advantages of the present disclosure will become better understood with reference to the following description and appended claims. The accompanying drawings, which are incorporated in and constitute a part of this specification, illustrate embodiments of the present disclosure and, together with the description, serve to explain the principles of the present disclosure.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 illustrates a perspective view of one embodiment of a superconducting magnet according to the present disclosure;

FIG. 2 illustrates a transparent, perspective view of one embodiment of the superconducting magnet of FIG. 1, particularly illustrating internal components of the superconducting magnet;

FIG. 3 illustrates a perspective view of one embodiment of a superconducting switch of a superconducting magnet according to the present disclosure;

FIG. 4 illustrates a detailed view of the superconducting switch of FIG. 3;

FIG. 5 illustrates a detailed, perspective view of the superconducting switch of FIG. 4, particularly illustrating the superconducting winding and the thermal conduction member of the superconducting switch thermally coupled to a conductive rod;

FIG. 6 illustrates a detailed, perspective view of another embodiment of the superconducting switch according to the present disclosure, particularly illustrating the superconducting winding and the thermal conduction member of the superconducting switch electrically coupled to a tube;

FIG. 7 illustrates a simplified, schematic diagram of a superconducting magnet according to the present disclosure;

FIG. 8 illustrates a circuit diagram of an embodiment of a field charging system for a superconducting magnet according to the present disclosure;

FIG. 9 illustrates a schematic diagram of an embodiment of various components of a field charging system for a superconducting magnet according to the present disclosure;

FIG. 10 illustrates a partial, perspective view of various components of a field charging system for a superconducting magnet according to the present disclosure; and

FIG. 11 illustrates a flow diagram of an embodiment of method for energizing a plurality of superconducting coils of a superconducting magnet according to the present disclosure.

### DETAILED DESCRIPTION

Reference now will be made in detail to embodiments of the present disclosure, one or more examples of which are illustrated in the drawings. Each example is provided by way of explanation of the present disclosure, not limitation of the present disclosure. In fact, it will be apparent to those skilled in the art that various modifications and variations can be made in the present disclosure without departing from the scope of the present disclosure. For instance, features illustrated or described as part of one embodiment can be used with another embodiment to yield a still further embodiment. Thus, it is intended that the present disclosure covers such modifications and variations as come within the scope of the appended claims and their equivalents.

In general, the present disclosure is directed to a superconducting circuit having a flexible field charging system for a superconducting magnet, such as a superconducting generator. In an embodiment, for example, the superconducting circuit can include a first temperature region defining a first temperature and a second temperature region defining a second temperature higher than the first temperature. The superconducting circuit can also include a first component positioned within the first temperature region and a second component positioned within the second temperature region. As such, the field charging system of the superconducting circuit includes a flexible connection that electrically couples the first component and the second component. Accordingly, the flexible connection allows for displacement and motion between the first and second components due to thermal expansion and contraction caused by the different first and second temperatures. As such, the superconducting circuit allows for temperature differentials between regions of the superconducting magnet and reduces the likelihood that the superconducting magnet will be damaged as a result thereof.

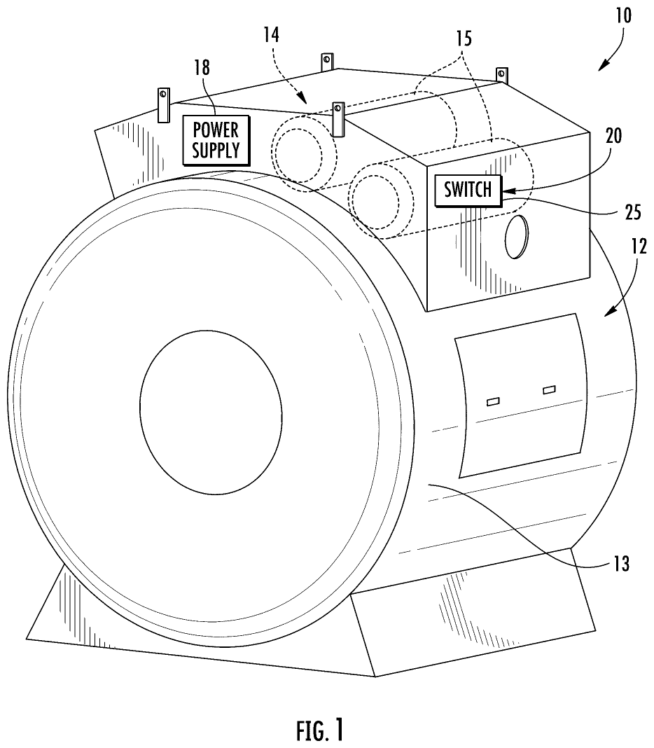

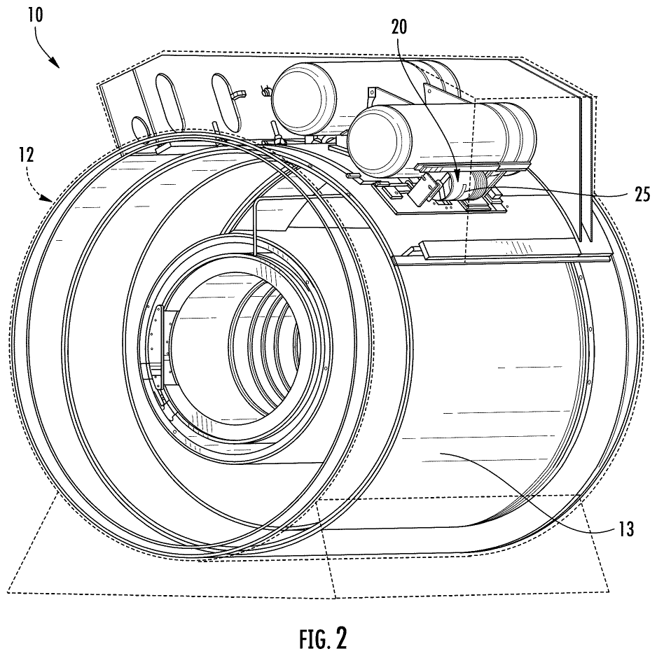

Referring now to the figures, FIGS. 1-3 illustrate perspective views of one embodiment of a superconducting magnet 10 according to the present disclosure. Such superconducting magnets are useful in a variety of applications, including but not limited to magnetic resonance imaging (MRI) machines, NMR spectrometers, generators (e.g., such as wind turbine generators), mass spectrometers, fusion reactors, particle accelerators, levitation, guidance, and propulsion, and similar. In particular, FIG. 1 illustrates an overall, perspective view of one embodiment of the superconducting magnet 10 according to the present disclosure; FIG. 2 illustrates a transparent, perspective view of one embodiment of the superconducting magnet 10 according to the present disclosure; and FIG. 3 illustrates an internal, perspective view of one embodiment of the superconducting magnet 10 according to the present disclosure.

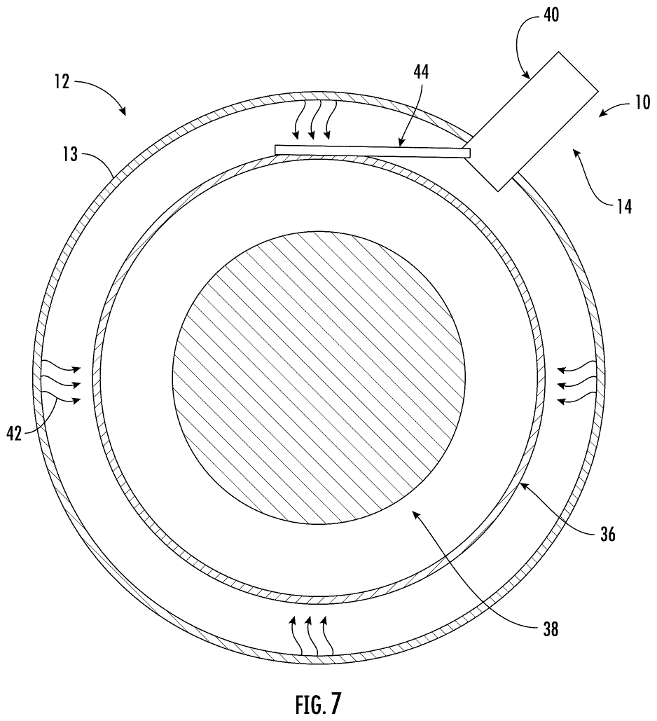

In particular, as shown in FIG. 2, the superconducting magnet 10 includes a thermally insulated container 12, which is generally referred to as a cryostat. As used herein, a cryostat generally refers to a vessel that contains a cryogenically cold system. Moreover, as shown in FIG. 3, the thermally insulated container 12 of the superconducting magnet 10 includes a superconducting circuit 16 having one or more superconducting coils 23 inside the thermally insulated container 12, supported by an internal structure 29. Accordingly, in such embodiments, the thermally insulated container 12 insulates the superconducting circuit(s) 16 such that the wire(s) may be cooled to near absolute zero, e.g., to 10 Kelvin (K) and preferably to 4K. For example, as shown in FIG. 3, the thermally insulated container 12 may include a plurality of conduits 21 that carry liquid cryogen (e.g., helium, hydrogen, argon or others depending on operating temperature) from the tanks 15 to the internal structure 29 and/or throughout the inner wall of the thermally insulated container 12. Furthermore, in an embodiment, the inner part of the thermally insulated container 12 includes a vacuum vessel 13 and a thermal shield 36 (FIG. 7) that intercepts the thermal radiation and convection between the outside environment and the cold components within the thermally insulated container 12, thereby also minimizing radiation heat transfer.

More particularly, as shown, the superconducting circuit(s) 16 may be arranged in a coil shape and may be configured for generating a magnetic field. As shown particularly in FIG. 1, the superconducting magnet 10 further includes a power source 18 connected to a field charging system 20 for energizing the superconducting circuit(s) 16.

Thus, in its superconducting state, the superconducting circuit(s) 16 do not have an electrical resistance and therefore can conduct much larger electric currents than ordinary wire, creating intense magnetic fields. Furthermore, during operation, the superconducting circuit(s) 16 must be cooled below their critical temperature, the temperature at which the wire material changes from the normal resistive state and becomes a superconductor. Typically, the superconducting circuit(s) 16 are cooled to temperatures significantly below their critical temperature, because the lower the temperature, the better superconductive windings work—the higher the currents and magnetic fields they can stand without returning to their non-superconductive state.

Thus, as shown in the embodiment of FIGS. 1-3, the superconducting magnet 10 may further include a cooling system 14 for providing liquid cooling to cool the superconducting circuit(s) 16. More specifically, as shown, the cooling system 14 may include one or more cooling tanks 15 containing a cooling medium 17 or coolant (FIG. 3). For example, in an embodiment, the cooling medium 17 may be liquid helium, which has a boiling point of 4.2 Kelvin that is far below the critical temperature of the wire materials.

In one operating mode of the superconducting magnet 10, the superconducting circuit(s) 16 can be short-circuited with a piece of superconducting material once the magnet has been energized. In such embodiments, for example, the short circuit may be made by a field charging system 20 via a superconducting switch 25, sometimes referred to as a persistent switch. In other words, the superconducting switch 25 of the field charging system 20 generally refers to the piece of superconducting material inside the superconducting magnet 10 connected across the winding ends of the superconducting circuit(s) 16 with a heater that can raise its temperature above the transition temperature of the wire. This is provided because a superconducting switch normally exists in a low temperature, superconducting state and is normally wound in a bi-filar fashion to minimize its electrical inductance, so it shows zero resistance and negligible inductance in a superconducting state.

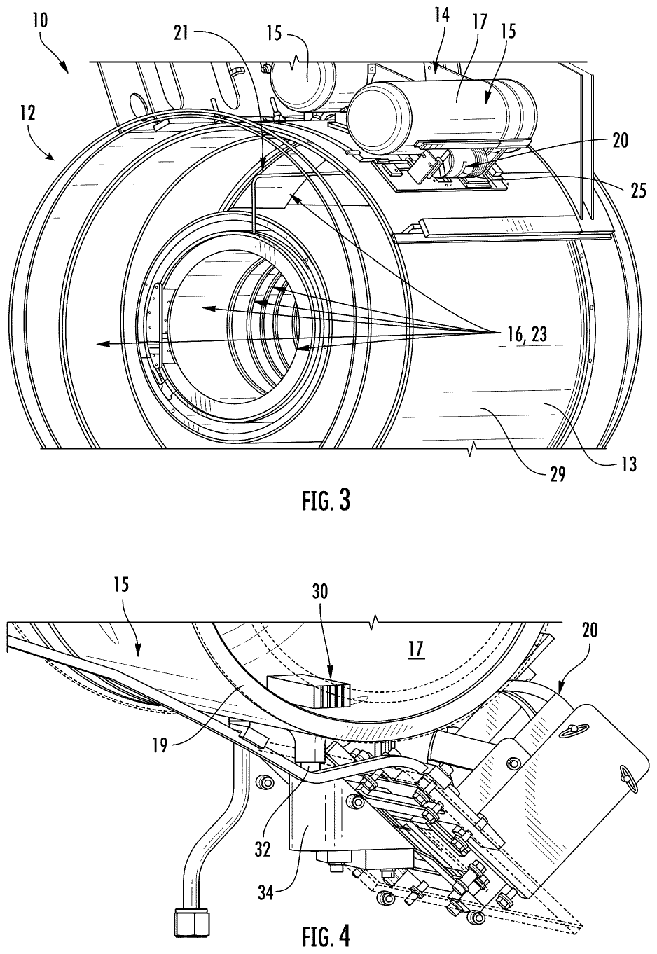

Further, as shown in FIG. 4, a heat exchanger 30, such as a finned-copper heat exchanger, may be included to allow the superconducting switch 25 of the field charging system 20 to be cooled by the liquid helium. Thus, when the heat exchanger 30 is turned off and the superconducting switch 25 of the field charging system 20 is cooled below its transition temperature, the superconducting circuit(s) 16 becomes a closed superconducting loop, so the power source 18 can be turned off, and persistent currents will flow for extended periods of time, preserving the magnetic field. Accordingly, an advantage of this persistent mode is that stability of the magnetic field is better than is achievable with the best power supplies, and no energy is needed to power the windings.

Moreover, when the superconducting magnet 10 is first turned on, the superconducting switch 25 of the field charging system 20 is heated above its transition temperature, such that the superconducting switch 25 of the field charging system 20 is resistive. To achieve this, a power source 18 is connected across a pair of current leads which are electrically coupled with superconducting coil 23 and field charging system 20. A current lead further includes at least one resistive current leads and one more high-temperature superconductor (HTS) current leads. The supply current is adjusted until the desired magnetic field is obtained, then the heater is turned off. The superconducting switch 25 of the field charging system 20 cools to its superconducting temperature, thereby short-circuiting the superconducting circuit(s) 16. Then, the power source 18 can be turned off.

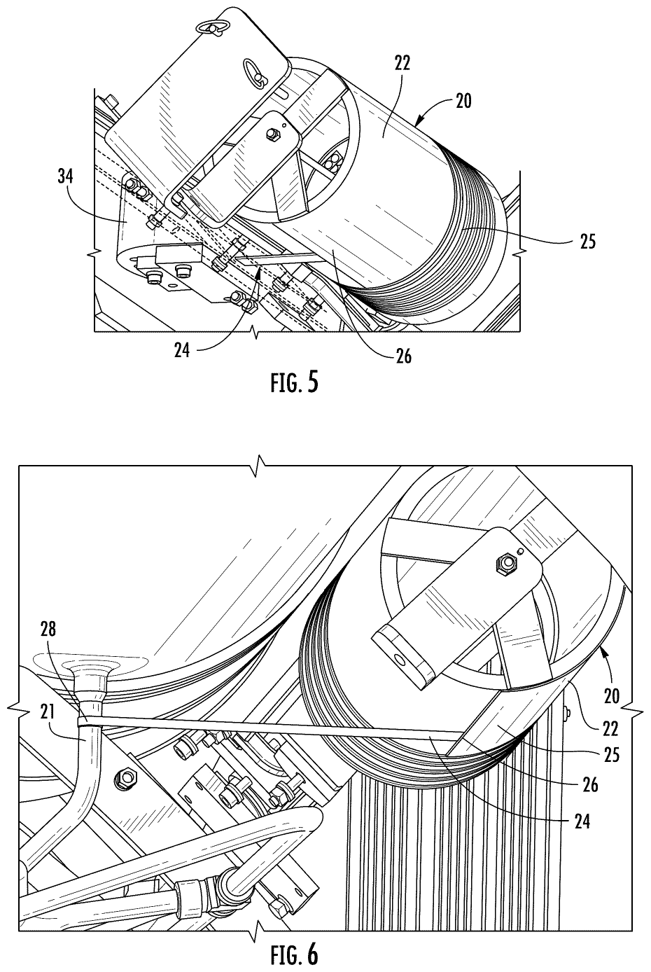

Referring now to FIGS. 4-6, the superconducting switch 25 of the field charging system 20 includes a superconducting winding 22 and a thermal conduction member 24. For example, in an embodiment, the superconducting winding may be a bi-filar wound superconducting winding to achieve a minimum inductance. Further, in an embodiment, the thermal conduction member 24 includes a first end 26 thermally coupled to the superconducting winding 22 and a second end 28 thermally coupled to the cooling tank 15. For example, as shown in FIG. 4, the heat exchanger 30 may be mounted within the cooling tank 15 and thermally connected to the field charging system 20 by a thermally-conductive rod 32, such as copper rod, which is secured to a tank wall 19 of the cooling tank 15 (FIG. 3), e.g., via brazing. Furthermore, as shown in FIGS. 4 and 5, an additional support structure 34 may be mounted to the thermally-conductive rod 32, e.g., via soldering, to which the second end 28 of the thermal conduction member 24 can be secured. In alternative embodiments, as shown in FIG. 6, the thermal conduction member 24 may be mounted to one of the conduits 21. In such embodiments, the thermal conduction member 24 may be mounted to a conduit 21 using one or more braided copper straps, which may be secured to the thermal conduction member 24 and the conduit 21.

Referring now to FIG. 7, a simplified, schematic diagram of a superconducting magnet 10 is illustrated. More specifically, as shown, the superconducting magnet 10 generally includes the cooling system 14, the vacuum vessel 13, a cold mass 38, a thermal shield 36 between the cold mass 38 and the vacuum vessel 13, and a cryocooler 40. Further, as shown, the cooling system 14 may be generally arranged with the thermal shield 36 of the superconducting magnet 10. In such embodiments, for example, the cold mass 38 may be a stationary component, such as a field winding assembly within which an armature winding assembly rotates. Furthermore, as an example, the vacuum vessel 13 may be a non-rotatable component supporting a field winding assembly. Thus, in such embodiments, the rotatable component may be oriented to rotate relative to the non-rotatable component during operation of the superconducting magnet 10. In such embodiments, the thermal shield 36 surrounds the cold mass 38 and intercepts and/or blocks radiation (as indicated by arrows 42) from the vacuum vessel 13. Further, as shown, heat is removed via a thermal bus/busbar 44 to the cryocooler 40, thereby blocking most radiation heat from the cold mass 38. Moreover, as shown, the thermal bus/busbar 44 of such configurations are attached to the top of the thermal shield 36 for connection to the cryocooler 40. The thermal shield 36 also intercepts heat conducted in through structural components.

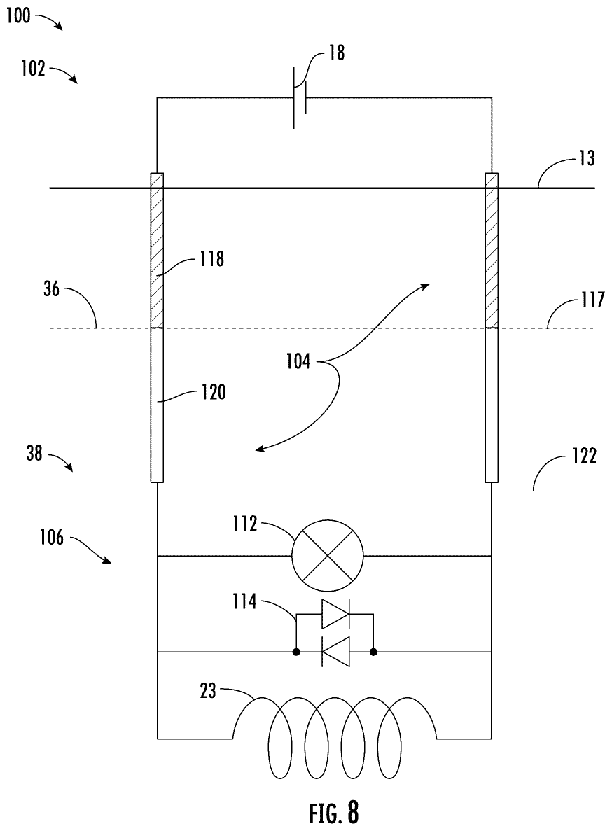

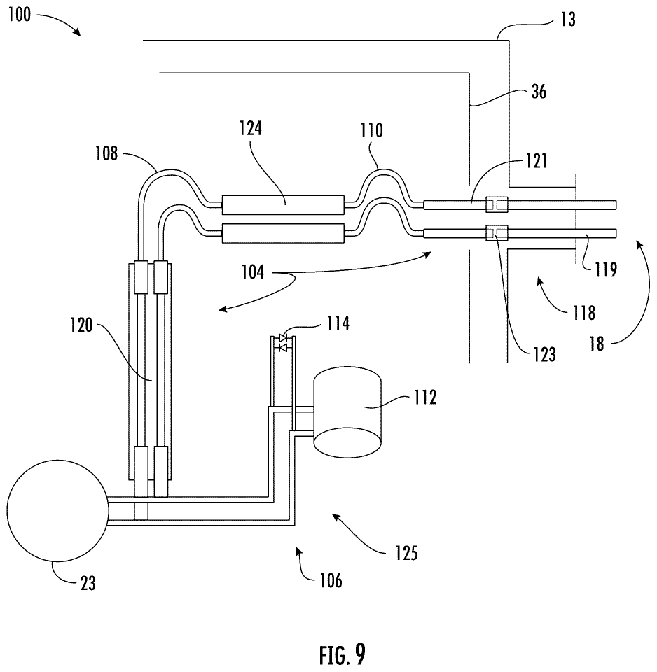

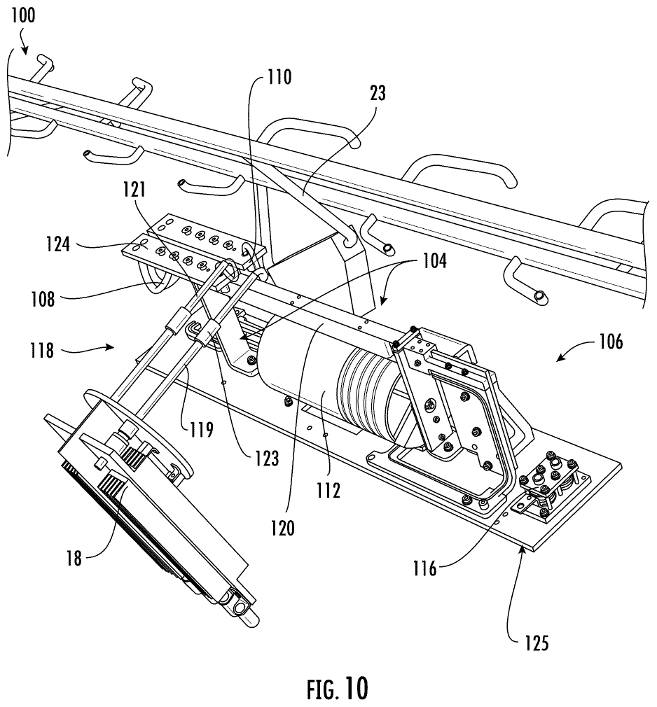

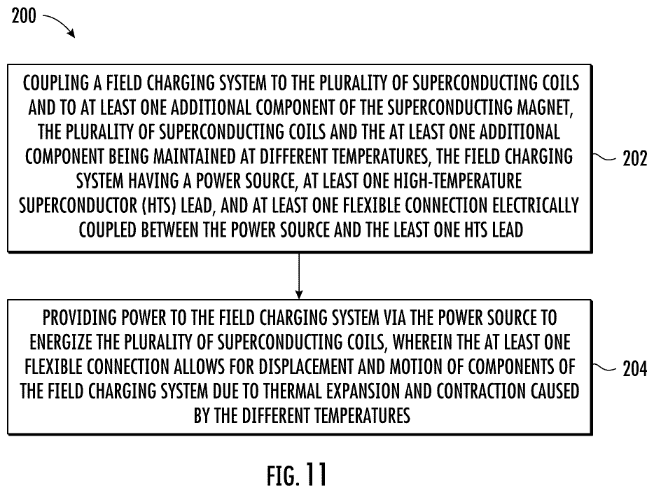

Referring now to FIGS. 8-10, various views of components of a field charging system 100 for energizing the superconducting coils of a superconducting magnet 10 described herein, is illustrated. In particular, FIG. 8 illustrates an embodiment of a circuit diagram 102 of the field charging system 100 according to the present disclosure. FIG. 9 illustrates a schematic diagram of an embodiment of various components of the field charging system 100 according to the present disclosure, particularly illustrating the field charging system 100 coupled between superconducting coils 23 and a power source 18 through the thermal shield 36 and the vacuum vessel 13. FIG. 10 illustrates a partial, perspective view of various components of the field charging system 100 according to the present disclosure.

As shown particularly in FIG. 8, the circuit diagram 102 generally includes a power source 18 for providing power to the field charging system 100 so as to energize the superconducting coils 23 (FIG. 9), similar to superconducting coils 23 illustrated in FIG. 3. Moreover, as shown in FIGS. 8-10, the field charging system 100 further includes a plurality of high current leads 104, the cold mass 38 which includes a superconducting switch assembly 106, and at least one flexible connection 108, 110. More specifically, as shown, the superconducting switch assembly 106 may generally include a superconducting switch 112 and a plurality of electrically protective diodes 114. The superconducting switch assembly 106 is electrically connected in parallel with an inductor that represents the superconducting coil 23.

Furthermore, as shown in FIGS. 8 and 9, the high current leads 104 described herein may include several types of leads, such as one or more resistive lead(s) 118 and/or one or more HTS lead(s) 120. In further embodiments, as shown particularly in FIG. 10, the resistive lead(s) 118 may be vacuum power feedthrough lines and further include one or more power connectors 119 coupled to the power source 18 (FIG. 8), one or more conductive rods 121 extending through the thermal shield 36 and/or the vacuum vessel 13, and/or one or more couplings 123 securing the power connector(s) 119 to the conductive rod(s) 121. Furthermore, in an embodiment, as shown in FIG. 10, the superconducting switch 112 and the HTS lead(s) 120 may be installed on a cold plate 125 that is mechanically and thermally coupled with a support structure of the plurality of superconducting field coils 23 (not shown in FIG. 10, but shown in FIGS. 8 and 9).

Accordingly, in an embodiment, the components of the field charging system 100 are configured to connect across multiple components of the superconducting magnet 10 such that various components thereof may be placed in different regions having different temperatures. For example, as shown particularly in FIG. 8, the superconducting switch assembly 106 may be in a first region maintained at a first temperature, as indicated below dotted line 122. The first temperature region may have a temperature less than about 10 Kelvin (K), such as less than about 8 K, such as less than about 5 K. Moreover, as shown, the warm end of the at least one of the HTS lead(s) 120 may be in a second region maintained at a different, second temperature, as indicated between dotted lines 117 and 122. The cold end of the HTS lead(s) 120 may be connected in the first temperature region. In such embodiments, the second temperature region may have a temperature that is greater than the first region. For example, the second temperature region may have a temperature ranging from about 20 K to about 70 K, such as about 25 K to about 65 K, such as about 30 K to about 60 K, such as about 35 K to about 55K. Furthermore, the power source 18 and/or the one or more resistive lead(s) 118 may be in a third region maintained at a third temperature, as indicated by the above-dotted line 117. In particular embodiments, the third temperature region may be a temperature higher than both the first temperature region and the second temperature region. For example, the third temperature region may be near ambient operating temperature such as greater than 200 K, such as greater than about 250 K, such as greater than about 300 K.

Accordingly, the flexible connection(s) 108, 110 may be provided to allow for displacement and motion of components of the field charging system 100 due to thermal expansion and contraction caused by the different temperatures at the first, second, and third temperature regions. Thus, as shown particularly in FIG. 9, one or more pairs of the flexible connection(s) 108, 110 may be electrically coupled between the superconducting coils 23 and the power source 18 and/or the HTS lead(s) 120.

In an embodiment, for example, the flexible connections 108, 110 may include a first pair 108 of flexible connections and a second pair 110 of flexible connections. Moreover, in an embodiment, the flexible connections 108, 110 described herein may be one or more braided wires or a foil member. In addition, as shown in FIG. 9, the field charging system 100 may also include one or more thermal plates 124, such as a pair of thermal plates, coupled between the first and second pairs 108, 110 of flexible connections. For example, the first pair 108 of flexible connections may be placed on one location or end of the one or more thermal plates 124 and the second pair 110 of flexible connections may be placed on another location end of the one or more thermal plates 124.

In an embodiment, the first temperature region may refer to a location in which the cold mass (or superconducting coil 23) is placed. In the same embodiment, the second temperature region may refer to a location in which the thermal shield 36 is placed. The HTS lead(s) 120 may then be secured to the thermal shield 36 at the second temperature region. Moreover, in the same embodiment, the third temperature region may refer to a location in which the vacuum vessel 13 is placed. Further, in the same embodiment, the one or more thermal plates 124 may be thermally anchored to the second temperature region so as to keep the warm end of the HTS lead(s) 120 at the second temperature.

In further embodiments, the HTS lead(s) 120 described herein may be formed from a superconducting material, such as a ceramic, bismuth strontium calcium copper oxide (BSCCO), or yttrium barium copper oxide (YBCO). Furthermore, in an embodiment, the resistive lead(s) 118 may be formed from a copper, brass, phosphor bronze, or any combination of these materials.

Referring now to FIG. 11, a flow diagram of an embodiment of a method 200 of energizing a plurality of superconducting coils of a superconducting magnet according to the present disclosure is illustrated. In general, the method 200 will be described herein with reference to the superconducting magnet 10, the superconducting circuit 16, and/or the field charging system 100 described above with reference to FIGS. 1-10. However, it should be appreciated by those of ordinary skill in the art that the disclosed method 200 may generally be utilized with any superconducting magnet having any suitable configuration. In addition, although FIG. 11 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown at (202), the method 200 includes coupling a field charging system to the plurality of superconducting coils and to at least one additional component of the superconducting magnet. In addition, in an embodiment, the plurality of superconducting coils and the additional component are maintained at different temperatures. Further, as described herein, the field charging system has a power source, at least one HTS lead, and at least one flexible connection electrically coupled between the power source and the least one HTS lead. Thus, as shown at (204), the method 200 includes providing power to the field charging system via the power source to energize the plurality of superconducting coils. Accordingly, by energizing the plurality of superconducting coils in this manner, the flexible connection(s) allows for displacement and motion of components of the field charging system that result from thermal expansion and contraction caused by the different temperatures.

Various aspects and embodiments of the present invention are defined by the following numbered clauses:
Clause 1. A superconducting circuit for a superconducting magnet, the superconducting circuit comprising:
a first temperature region defining a first temperature;
a second temperature region defining a second temperature, the second temperature being higher than the first temperature;
at least one first component positioned within the first temperature region;
at least one second component positioned within the second temperature region; and
a field charging system, comprising:
   at least one flexible connection electrically coupling the first component and the second component,
   wherein the at least one flexible connection allows for displacement and motion between the first and second components due to thermal expansion and contraction caused by the different first and second temperatures.
Clause 2. The superconducting circuit of clause 1, wherein the first component comprises a plurality of superconducting coils and the second component comprises at least one of a thermal shield surrounding the plurality of superconducting field coils, wherein the field charging system is configured to energize the plurality of superconducting coils.
Clause 3. The superconducting circuit of clause 2, wherein the field charging system further comprises a plurality of high current leads and a superconducting switch.
Clause 4. The superconducting circuit of clause 3, wherein the plurality of high current leads further comprises a pair of high-temperature superconductor (HTS) leads and a pair of resistive leads, the pair of resistive leads being one or more power feedthrough lines extending through a vacuum vessel and coupled to the pair of HTS leads via the at least one flexible connection, the pair of HTS leads coupled to the plurality of superconducting field coils and the superconducting switch.
Clause 5. The superconducting circuit of clause 4, wherein the superconducting switch is installed on a cold plate mechanically and thermally coupled with a support structure of the plurality of superconducting field coils, and wherein the pair of HTS leads are secured onto the cold plate.
Clause 6. The superconducting circuit of clauses 4-5, wherein the connection between the pair of HTS leads and the pair of resistive leads comprises the at least one flexible connection and a thermal plate.
Clause 7. The superconducting circuit of clause 4-6, wherein the pair of resistive leads comprise a copper, brass, phosphor bronze, or a combination thereof.
Clause 8. The superconducting circuit of any of the preceding clauses, wherein the first temperature is less than about 10 Kelvin (K) and the second temperature is between about 35 K to about 55 K.
Clause 9. The superconducting circuit of any of the preceding clauses, further comprising a third temperature region defining a third temperature higher than the first and second temperature, wherein a third component is placed within the third temperature region and connected to the second component via a second flexible connection of the at least one flexible connection.
Clause 10. The superconducting circuit of clause 9, wherein the second component comprises a thermal shield with at least one electrical component placed therein and the third component comprises a vacuum vessel comprising at least one electrical component placed therein.
Clause 11. The superconducting circuit of any of the preceding clauses, wherein the at least one flexible connection comprises a braided wire.
Clause 12. A field charging system for energizing a plurality of superconducting coils of a superconducting magnet, the field charging system comprising:
at least one high-temperature superconductor (HTS) lead connecting a first and second temperature, the second temperature being different from the first temperature;
a power source at a different, third temperature for providing power to the field charging system to energize the plurality of superconducting coils; and
at least one flexible connection electrically coupled between the at least one HTS lead at the first temperature and the power source at the second temperature;
wherein the at least one flexible connection allows for displacement and motion of components of the field charging system due to thermal expansion and contraction caused by the different first and second temperatures.
Clause 13. The field charging system of clause 12, wherein the power source comprises one or more power feedthrough lines extending through a vacuum vessel and a thermal shield of the superconducting magnet.
Clause 14. The field charging system of clause 13, further comprising one or more rod members coupled to the one or more power feedthrough lines at least partially within the thermal shield.
Clause 15. The field charging system of clause 14, wherein the at least one flexible connection comprises at least one first flexible connection and at least one second flexible connection, the at least one first flexible connection coupled to the one or more rod members and a first location on at least one thermal plate, the at least one second flexible connection coupled to a second location on the at least one thermal plate and the least one HTS lead.
Clause 16. The field charging system of clauses 12-15, further comprising a superconducting switch, the at least one HTS lead and the superconducting switch coupled to the plurality of superconducting coils.
Clause 17. A method for energizing a plurality of superconducting coils of a superconducting magnet, the method comprising:
coupling a field charging system to the plurality of superconducting coils and to at least one additional component of the superconducting magnet, the plurality of superconducting coils and the at least one additional component being maintained at different temperatures, the field charging system having a power source, at least one high-temperature superconductor (HTS) lead, and at least one flexible connection electrically coupled between the power source and the at least one HTS lead; and
providing power to the field charging system via the power source to energize the plurality of superconducting coils,
wherein the at least one flexible connection allows for displacement and motion of components of the field charging system due to thermal expansion and contraction caused by the different temperatures.
Clause 18. The method of clause 17, wherein the power source comprises one or more power feedthrough lines extending through a vacuum vessel and a thermal shield of the superconducting magnet.
Clause 19. The method of clause 18, further comprising coupling one or more rod members to the one or more power feedthrough lines.
Clause 20. The method of clause 19, wherein the at least one flexible connection comprises at least one first flexible connection and at least one second flexible connection, the method further comprising:
coupling the at least one first flexible connection to the one or more rod members at a first location on at least one thermal plate; and
coupling the at least one second flexible connection to a second location on the at least one thermal plate and the at least one HTS lead.

This written description uses examples to disclose the present disclosure, including the best mode, and also to enable any person skilled in the art to practice the present disclosure, including making and using any devices or systems and performing any incorporated methods. The patentable scope of the present disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A superconducting circuit for a superconducting magnet, the superconducting circuit comprising:
a first temperature region defining a first temperature;
a second temperature region defining a second temperature, the second temperature being higher than the first temperature;
at least one first component positioned within the first temperature region;
at least one second component positioned within the second temperature region; and
a field charging system, comprising:
at least one flexible connection electrically coupling the first component and the second component,
wherein the at least one flexible connection allows for displacement and motion between the first and second components due to thermal expansion and contraction caused by the different first and second temperatures.

2. The superconducting circuit of claim 1, wherein the first component comprises a plurality of superconducting coils and the second component comprises at least one of a thermal shield surrounding the plurality of superconducting field coils, wherein the field charging system is configured to energize the plurality of superconducting coils.

3. The superconducting circuit of claim 2, wherein the field charging system further comprises a plurality of high current leads and a superconducting switch.

4. The superconducting circuit of claim 3, wherein the plurality of high current leads further comprises a pair of high-temperature superconductor (HTS) leads and a pair of resistive leads, the pair of resistive leads being one or more power feedthrough lines extending through a vacuum vessel and coupled to the pair of HTS leads via the at least one flexible connection, the pair of HTS leads coupled to the plurality of superconducting field coils and the superconducting switch.

5. The superconducting circuit of claim 4, wherein the superconducting switch is installed on a cold plate mechanically and thermally coupled with a support structure of the plurality of superconducting field coils, and
wherein the pair of HTS leads are secured onto the cold plate.

6. The superconducting circuit of claim 4, wherein the connection between the pair of HTS leads and the pair of resistive leads comprises the at least one flexible connection and a thermal plate.

7. The superconducting circuit of claim 4, wherein the pair of resistive leads comprise a copper, brass, phosphor bronze, or a combination thereof.

8. The superconducting circuit of claim 1, wherein the first temperature is less than about 10 Kelvin (K) and the second temperature is between about 35 K to about 55 K.

9. The superconducting circuit of claim 1, further comprising a third temperature region defining a third temperature higher than the first and second temperature, wherein a third component is placed within the third temperature region and connected to the second component via a second flexible connection of the at least one flexible connection.

10. The superconducting circuit of claim 9, wherein the second component comprises a thermal shield with at least one electrical component placed therein and the third component comprises a vacuum vessel comprising at least one electrical component placed therein.

11. The superconducting circuit of claim 1, wherein the at least one flexible connection comprises a braided wire.

12. A field charging system for energizing a plurality of superconducting coils of a superconducting magnet, the field charging system comprising:
at least one high-temperature superconductor (HTS) lead connecting a first and second temperature, the second temperature being different from the first temperature;
a power source at a different, third temperature for providing power to the field charging system to energize the plurality of superconducting coils; and
at least one flexible connection electrically coupled between the at least one HTS lead at the first temperature and the power source at the second temperature;
wherein the at least one flexible connection allows for displacement and motion of components of the field charging system due to thermal expansion and contraction caused by the different first and second temperatures.

13. The field charging system of claim 12, wherein the power source comprises one or more power feedthrough lines extending through a vacuum vessel and a thermal shield of the superconducting magnet.

14. The field charging system of claim 13, further comprising one or more rod members coupled to the one or more power feedthrough lines at least partially within the thermal shield.

15. The field charging system of claim 14, wherein the at least one flexible connection comprises at least one first flexible connection and at least one second flexible connection, the at least one first flexible connection coupled to the one or more rod members and a first location on at least one thermal plate, the at least one second flexible connection coupled to a second location on the at least one thermal plate and the least one HTS lead.

16. The field charging system of claim 12, further comprising a superconducting switch, the at least one HTS lead and the superconducting switch coupled to the plurality of superconducting coils.

17. A method for energizing a plurality of superconducting coils of a superconducting magnet, the method comprising:
coupling a field charging system to the plurality of superconducting coils and to at least one additional component of the superconducting magnet, the plurality of superconducting coils and the at least one additional component being maintained at different temperatures, the field charging system having a power source, at least one high-temperature superconductor (HTS) lead, and at least one flexible connection electrically coupled between the power source and the at least one HTS lead; and
providing power to the field charging system via the power source to energize the plurality of superconducting coils,
wherein the at least one flexible connection allows for displacement and motion of components of the field charging system due to thermal expansion and contraction caused by the different temperatures.

18. The method of claim 17, wherein the power source comprises one or more power feedthrough lines extending through a vacuum vessel and a thermal shield of the superconducting magnet.

19. The method of claim 18, further comprising coupling one or more rod members to the one or more power feedthrough lines.

20. The method of claim 19, wherein the at least one flexible connection comprises at least one first flexible connection and at least one second flexible connection, the method further comprising:
coupling the at least one first flexible connection to the one or more rod members at a first location on at least one thermal plate; and
coupling the at least one second flexible connection to a second location on the at least one thermal plate and the at least one HTS lead.
